(19) United States
(12) Patent Application Publication
(10) Pub. No.: US 2004/0019534 A1
(43) Pub. Date: Jan. 29, 2004

(54) Methods and apparatus for purchasing a replacement part for a product

(76) Inventors: Kevin Callahan, Crystal Lake, IL (US); Daryle Gibbens, Leander, TX (US)

Correspondence Address: MICHAEL BEST & FRIEDRICH, LLP, 100 E WISCONSIN AVENUE, MILWAUKEE, WI, 53202, US

(21) Appl. No.: 10/206,137

(22) Filed: Jul. 26, 2002

(51) Int. Cl. G06F 17/60

(52) U.S. Cl. 705/27

(57) ABSTRACT

A system for facilitating the purchase of a replacement part online with the aid of an interactive exploded view of the product the replacement part goes into are disclosed. Initially, the system helps an online user identify a particular product for which a replacement part is desired. Once the product is identified (e.g., by model number), the system transmits an interactive exploded view of the product. Preferably, the interactive exploded view is a perspective view of at least a portion of the identified product showing how the parts fit together even though most of each part is visible. The interactive exploded view includes selectable regions for each replacement part. When the user clicks on a part in the interactive exploded view, the part is added to an electronic shopping cart. Subsequently, the shopping cart order may be fulfilled by an appropriate parts vendor.

### TECHNICAL FIELD

The present invention relates in general to electronic commerce and, in particular, to methods and apparatus for purchasing a replacement part for a product via the Internet with the aid of an interactive exploded view.

### BACKGROUND

Often, people need replacement parts for products they own. For example, a refrigerator door may need a new hinge or a lawn mower may need a new blade. In attempting to locate a particular replacement part, the product owner has several options. First, the product owner could call a repair service. A repair person could then identify, provide, and replace the part. However, for simple jobs, repair service are unnecessarily expensive because of the time spent by the repair person. In addition, the product owner may have to schedule an appointment sometime in the future and wait at home for the repair person to arrive, thereby causing a burdensome delay. Further, the repair person may have to make two trips to the product owner's home if he does not have the necessary replacement part ion hand.

A second option, which may eliminate some of the delay and expense associated with a “house call,” is to have the product owner bring the product into a repair shop. However, this option is only practical for easily transported products. In addition, the cost associated with the repair person is still high relative to the product owner doing the job himself.

A third option is to have the product owner order the required replacement part over the phone or via a website. However, identifying the needed replacement part to the order taker is often difficult. Many parts are to small to include visible part numbers. In addition, part numbers are not universally unique. Typically, the product the part goes into must also be identified to put the part number into context.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of a communications system illustrating an exemplary environment of use for the disclosed system.

FIG. 2 is a more detailed block diagram of one of the client devices illustrated in FIG. 1.

FIG. 3 is a more detailed block diagram showing one embodiment of the replacement parts website server illustrated in FIG. 1.

FIG. 4 is a more detailed block diagram showing another embodiment of the replacement parts website server illustrated in FIG. 1.

FIG. 5 is a flowchart of a process for purchasing a replacement part online using an interactive exploded view.

FIG. 6 is a screen-shot of an exemplary home page used to access an online replacement part web page.

FIG. 7 is a screen-shot of an exemplary online replacement part web page used to enter a model number or a part number.

FIG. 8 is a screen-shot of an exemplary online replacement part web page used to access help pages for locating a model number on a product.

FIG. 9 is a screen-shot of an exemplary help page for locating a model number on a product.

FIG. 10 is a screen-shot of another exemplary help page for locating a model number on a product.

FIG. 11 is a screen-shot of an exemplary online replacement part web page used to select a model number from a list of model numbers.

FIG. 12 is a screen-shot of an exemplary online replacement part web page used to select a product subsection from a list of product subsections.

FIG. 13 is a screen-shot of an exemplary online replacement part web page used to display a plurality of parts associated with a product subsection as a text list.

FIG. 14 is a screen-shot of an exemplary online replacement part web page used to display a plurality of parts associated with a product subsection as an interactive exploded view diagram.

FIG. 15 is a screen-shot of another exemplary online replacement part web page used to display a plurality of parts associated with a product subsection as an interactive exploded view diagram.

FIG. 16 is a screen-shot of an exemplary online replacement part web page used to display an online shopping cart.

### DETAILED DESCRIPTION OF EXEMPLARY EMBODIMENTS

In general, the methods and apparatus described herein facilitate the purchase of a replacement part online with the aid of an interactive exploded view of the product the replacement part goes into. Initially, the methods and apparatus help an online user identify a particular product for which a replacement part is desired. Once the product is identified (e.g., by model number), the disclosed system transmits an interactive exploded view of the product. Preferably, the interactive exploded view is a perspective view of at least a portion of the identified product showing how the parts fit together even though most of each part is visible. The interactive exploded view includes selectable regions for each replacement part. When the user clicks on a part in the interactive exploded view, the part is added to an electronic shopping cart. Subsequently, the shopping cart order may be fulfilled by an appropriate parts vendor.

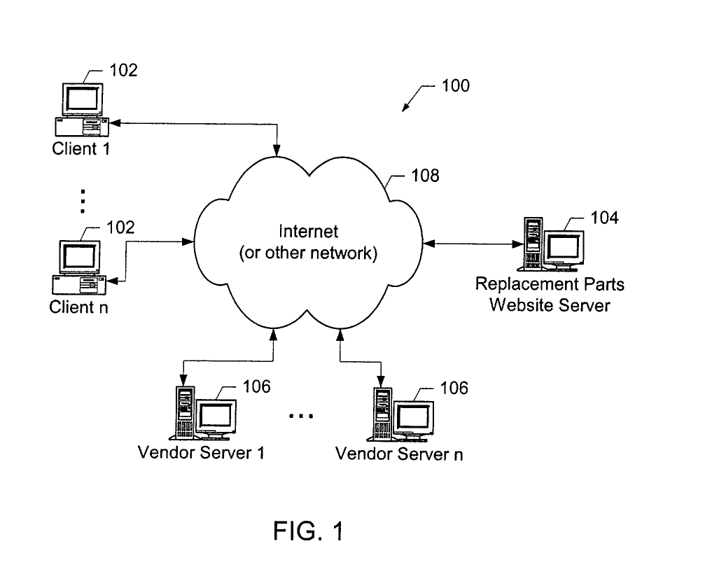

A high level block diagram of an exemplary network communications system 100 capable of employing the teachings of the present invention is illustrated in FIG. 1. Typically, the system 100 includes one or more client devices 102, one or more replacement parts website servers 104, and one or more vendor servers 106. Each of these devices may communicate with each other via a connection to the Internet or some other wide area network 108.

Typically, replacement parts website servers 104 store a plurality of files, programs, and/or web pages for use by the client devices 102 and/or the vendor servers 106. One replacement parts website server 104 may handle requests from a large number of clients 102. Accordingly, each server 104 is typically a high end computer with a large storage capacity, one or more fast microprocessors, and one or more high speed network connections. Conversely, relative to a typical server 104, each client device 102 typically includes less storage capacity, a single microprocessor, and a single network connection.

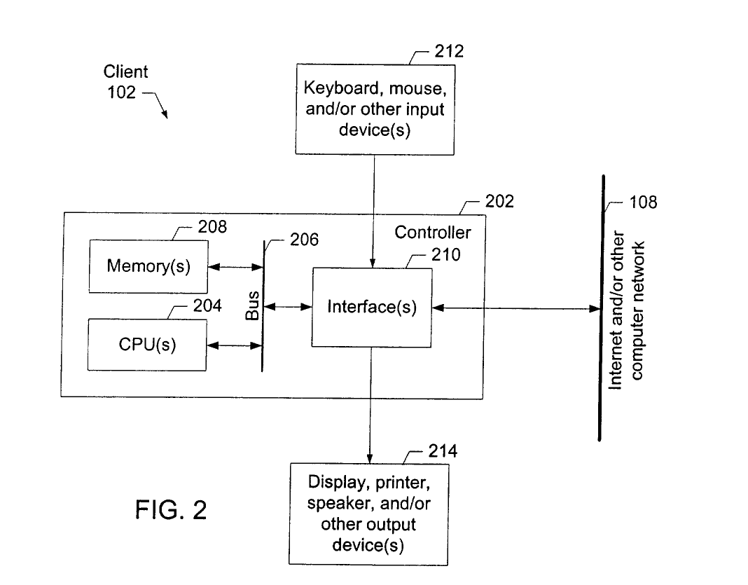

A more detailed block diagram of a client device 102 is illustrated in FIG. 2. The client device may be a personal computer (PC), a personal digital assistant (PDA), an Internet appliance, a cellular telephone, or any other communication device. The client 102 includes a controller 202 which preferably includes a central processing unit 204 electrically coupled by an address/data bus 206 to a memory device 208 and an interface circuit 210. The CPU 204 may be any type of well known CPU, such as an Intel Pentium™ processor. The memory device 208 preferably includes volatile memory and non-volatile memory. Preferably, the memory device 208 stores a software program that interacts with the replacement parts website server 104 as described below. This program may be executed by 25 the CPU 204 in a well known manner. The memory device 208 may also store digital data indicative of documents, files, programs, web pages, etc. retrieved from a server 104, 106 and/or loaded via an input device 212.

The interface circuit 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, mouse, touch screen, track pad, track ball, isopoint, and/or a voice recognition system.

One or more displays, printers, speakers, and/or other output devices 214 may also be connected to the controller 202 via the interface circuit 210. The display 214 may be cathode ray tube (CRTs), liquid crystal displays (LCDs), or any other type of display. The display 214 generates visual displays of data generated during operation of the client 102. The display 214 is typically used to display web pages received from the replacement parts website server 104. The visual displays may include prompts for human operator input, run time statistics, calculated values, detected data, etc.

The client 102 may also exchange data with other devices via a connection to the network 108. The network connection may be any type of network connection, such as an Ethernet connection, digital subscriber line (DSL), telephone line, coaxial cable, etc. Users of the system 100 may be required to register with the replacement parts website server 104. In such an instance, each user may choose a user identifier and/or a password which may be required for the activation of services. The user identifier and password may be passed across the Internet 108 using encryption built into the user's browser. Alternatively, the user identifier and/or password may be assigned by the replacement parts website server 104.

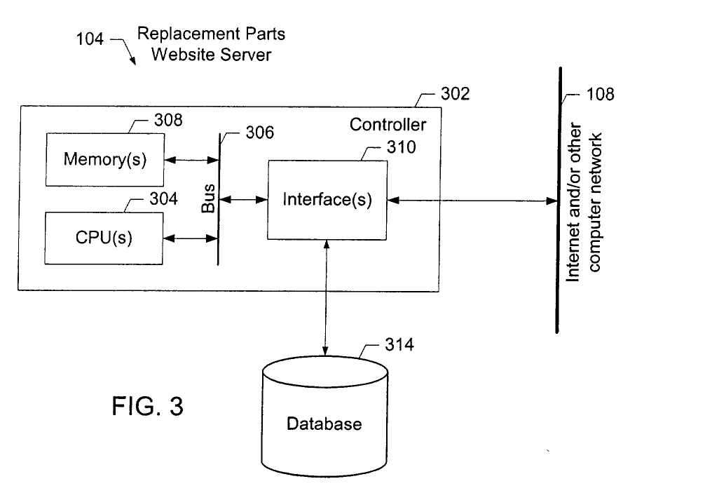

A more detailed block diagram of a replacement parts website server 104 is illustrated in FIG. 3. Like the client device 102, the controller 302 in the server 104 preferably includes a central processing unit 304 electrically coupled by an address/data bus 306 to a memory device 308 and a network interface circuit 310. However, the sever controller 302 is typically more powerful than the client controller 202. Again, the CPU 304 may be any type of well known CPU, such as an Intel Pentium™ processor, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the server 104. The memory device 308 and/or a separate database 314 also store files, programs, web pages, etc. for use by servers 104, 106 and/or the client devices 102.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

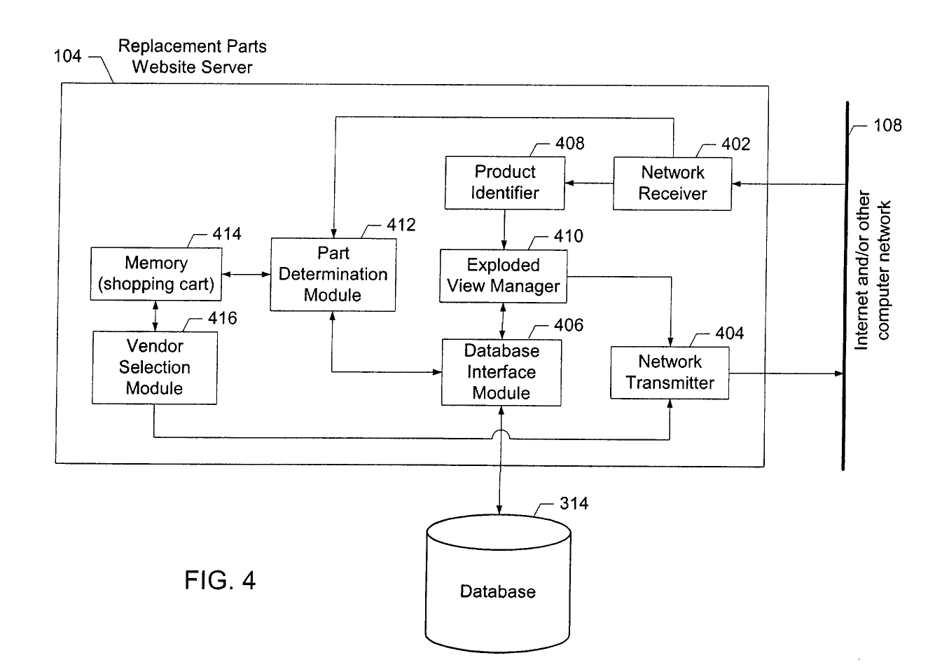

A more detailed block diagram of another embodiment of the replacement parts website server 104 is illustrated in FIG. 4. In this embodiment, the server 104 includes a plurality of interconnected modules 402-416. Each of the modules may be implemented by a microprocessor executing software instructions and/or conventional electronic circuitry. In addition, a person of ordinary skill in the art will readily appreciate that certain modules may be combined or divided according to customary design constraints.

For the purpose of receiving web page requests, purchase requests, hyperlink selections, region identifiers, product identification messages, model numbers, part numbers, customer identifiers, user names, passwords, cookie data, and other data, the replacement parts website server 104 includes a network receiver 402. The network receiver 402 is operatively coupled to the network 108 in a well known manner. For example, the network receiver 402 may be an Ethernet interface circuit electrically coupled to the Internet via an Ethernet cable.

For the purpose of transmitting web pages, interactive exploded views, invisible overlays, model number location diagrams, two dimensional product diagrams, three dimensional image data, software instructions, shopping cart data, order data, and other data, the replacement parts website server 104 includes a network transmitter 404. The network transmitter 404 is operatively coupled to the network 108 in a well known manner. For example, the network transmitter 404 may also be an Ethernet interface circuit electrically coupled to the Internet via an Ethernet cable.

For the purpose of storing data to the database 314 and retrieving data from the database 314, the replacement parts website server 104 includes a database interface module 406. The database interface module 406 is operatively coupled to the database 314. The database interface module 406 stores data received by the network receiver 402 and data transmitted by the network transmitter 404 in a well known manner. In particular, the database interface module 406 manages web pages, interactive exploded views, invisible overlays, model number location diagrams, two dimensional product diagrams, three dimensional image data, software instructions, shopping cart data, order data, and other data which is stored in the database 314.

For the purpose of determining a particular product based on a product identification message, the replacement parts website server 104 includes a product identifier 408. The product identifier 408 is operatively coupled to the network receiver 408. The product identification message preferably includes a model number entered into a data entry box of a web page. Alternatively, the model number may be selected from a list of hyperlinked model numbers and/or digital images (e.g., product shots) displayed on the web page. If the customer desires assistance in locating the model number on the product itself, the replacement part server 104 preferably includes a plurality of model number location diagrams categorized by product and/or manufacturer. For example, if the customer indicates he owns a Kenmore refrigerator, the replacement parts website server 104 may transmit one or more generic refrigerator diagrams leading the customer to the location of the model number.

For the purpose of retrieving an interactive exploded view from the database 314 and transmitting the interactive exploded view to a client device 102, the replacement parts website server 104 includes a view manager 410. The view manager 410 is operatively coupled to the product identifier 408, the database interface 406, and the network transmitter 404. The view manager 410 selects the interactive exploded view based on the product determined by the product identifier 408. The interactive exploded view preferably includes a perspective view of a plurality of replacement parts and an invisible overlay. Preferably, the parts are arranged in the interactive exploded view to show how the parts fit together even though most of each part is visible. The overlay defines a plurality of regions in the interactive exploded view which correspond to the plurality of parts.

In some embodiments, the interactive exploded view comprises a zoomable two dimensional image and optionally software instructions structured to manipulate the interactive exploded view. For example, two dimensional image data and a Java script may be downloaded to the client device 102. In this embodiment, the shape of the invisible overlay must change with the zoom level of the exploded view.

In some embodiments, the interactive exploded view comprises a rotatable three dimensional image and optionally software instructions structured to manipulate the interactive exploded view. For example, three dimensional image data and a Java script may be downloaded to the client device 102. In this embodiment, the shape of the invisible overlay must change with the viewing angle of the exploded view.

For the purpose of determining a unique replacement part based on selected region data received by the network receiver, the replacement parts website server 104 includes a part determination module 412. The part determination module 412 is operatively coupled to the network receiver 402. Preferably, the part determination module 412 looks up a part number in the database 314 based on the received region identifier. The region identifier is generated by a client device 102 when a user clicks on a part (and the corresponding portion of the invisible overlay) in the exploded view. The region identifier corresponds to the portion of the invisible overlay where the user clicked. For example, product XYZ may have ten replacement parts numbered XYZ1 through XYZ10. Accordingly, the overlay may have ten regions identified by the labels XYZ1 through XYZ10. Alternatively, the overly may be a generic X-Y coordinate system. In such an instance, the region identifier comprises an x-axis coordinate and a y-axis coordinate.

For the purpose of storing an electronic shopping cart, the replacement parts website server 104 includes a memory device 414. The memory device 414 is operatively coupled to the part determination module 412. The electronic shopping cart stores part orders in the memory device 414 in a conventional manner. For example, if the customer clicked on overlay region XYZ5, the electronic shopping cart may store XYZ5 in association with one or more customer identifiers such as the customer's name, password, shipping address, and credit card number. Of course, one or more customer identifiers may be stored and/or indirectly referenced by cookie data stored at a client device in a well known manner.

For the purpose of selecting a particular vendor from a plurality of vendors based on the replacement part, the replacement parts website server 104 includes a vendor selection module 416. The vendor selection module 416 is operatively coupled to the part determination module 412 and the network transmitter 404. The vendor selection module 416 selects a vendor facility associated with the replacement part from a plurality of vendor facilities and transmits order data identifying at least the replacement part and the shipping address to the selected vendor facility.

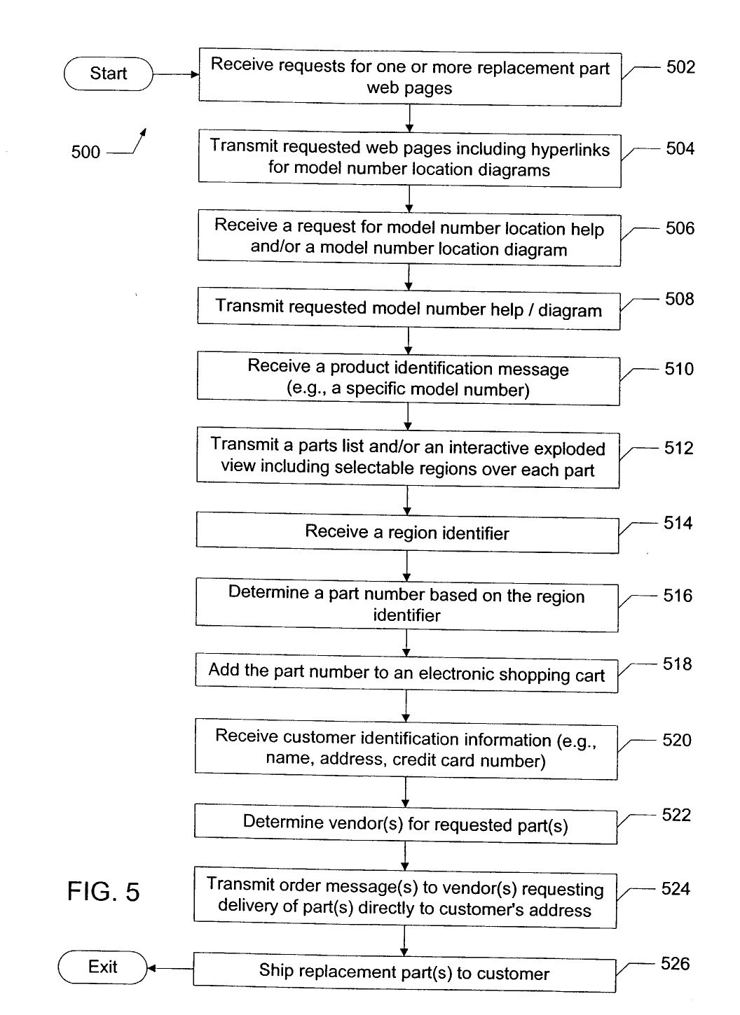

A flowchart of a process 500 for purchasing a replacement part online using an interactive exploded view is illustrated in FIG. 5. Preferably, the process 500 is embodied in a software program which is stored in the replacement parts website server memory 308 and executed by the server CPU 304 in a well known manner. However, some or all of the steps of the process 500 may be performed manually and/or by another device. Although the process 500 is described with reference to the flowchart illustrated in FIG. 5, a person of ordinary skill in the art will readily appreciate that many other methods of performing the acts associated with process 500 may be used. For example, the order of many of the steps may be changed without departing from the scope or spirit of the present invention. In addition, many of the steps described are optional.

Generally, the process 500 helps an online user identify a particular product for which a replacement part is desired. Once the product is identified (e.g., by model number), the process 500 transmits an interactive exploded view of the product. Preferably, the interactive exploded view is a perspective view of at least a portion of the identified product showing how the parts fit together even though most of each part is visible. The interactive exploded view includes selectable regions for each replacement part. When the user clicks on a part in the interactive exploded view, the process 500 adds the part to an electronic shopping cart. Subsequently, the shopping cart order may be fulfilled by an appropriate parts vendor.

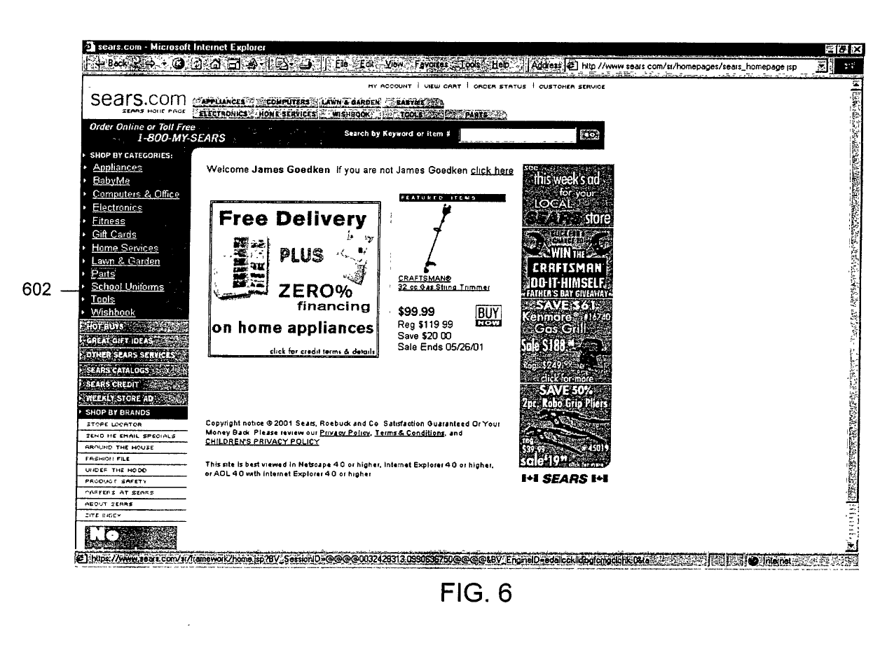

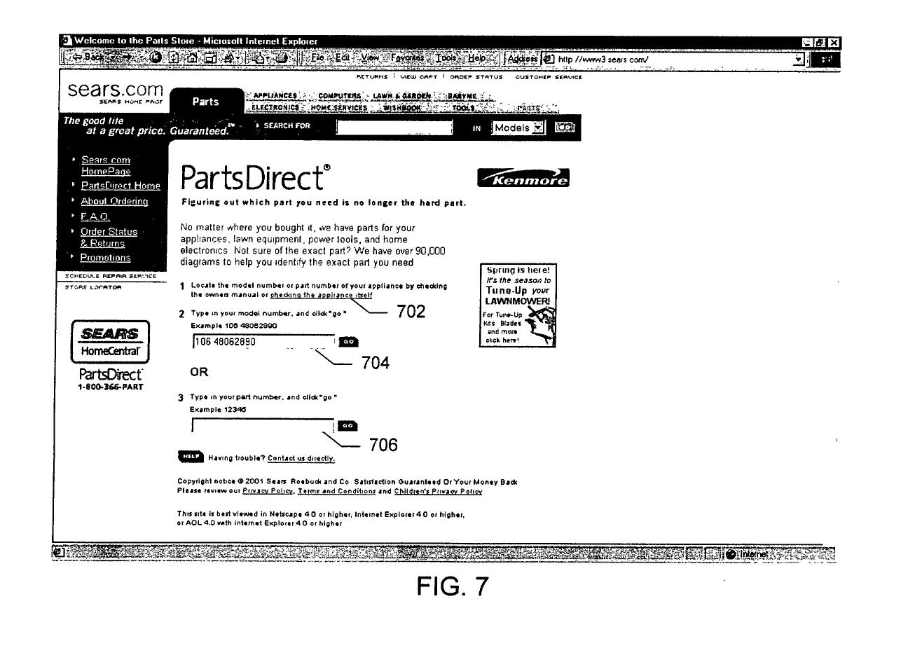

The process 500 begins when the replacement parts website server 104 receives a request from a client device 102 for one or more replacement part web pages (step 502). For example, a user may go to a general retail web page, such as Sears.com (see FIG. 6) and click on a “parts” hyperlink 602 to request a replacement parts web page (see FIG. 7). In response, the replacement parts website server 104 preferably transmits the requested web page to the client 102 (step 504). In the preferred embodiment, the transmitted web page (FIG. 7) includes a “help” hyperlink 702, a “model number” data entry box 704, and a “part number” data entry box 706.

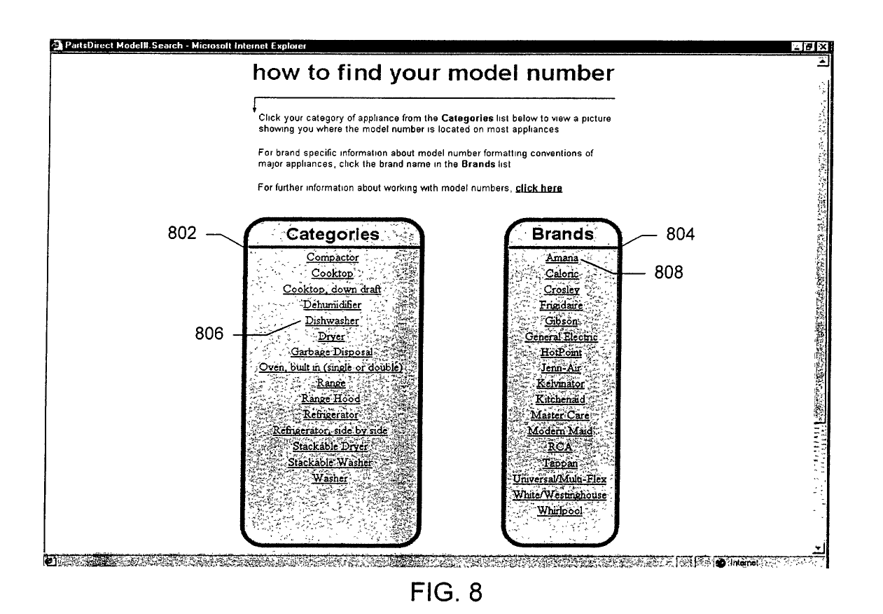

If the user selects the “help” hyperlink 702, the user's client device 102 preferably transmits a request for a “how to find” web page (see FIG. 8) to the replacement parts website server 104 (step 506). In the preferred embodiment, the “how to find” web page allows the user to locate a model number location diagram using a plurality of “product category” hyperlinks 802 or a plurality of “product brand” hyperlinks 804.

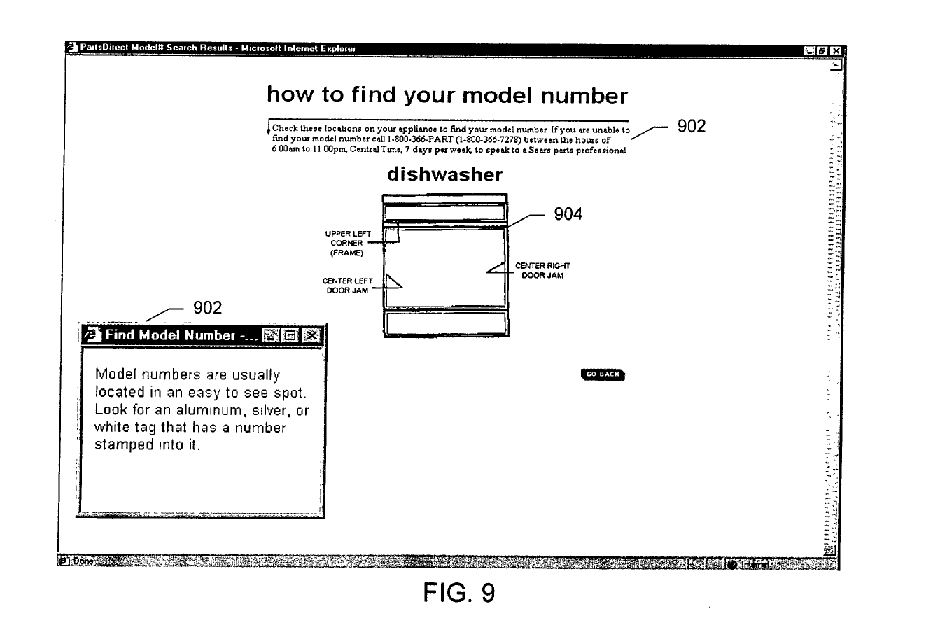

If the user selects one of the “product category” hyperlinks 802, the server 104 preferably responds with specific model number location help text and/or a model number location diagram (step 508). For example, if the user selects the “dishwasher” hyperlink 806, the replacement parts website server 104 may respond with a “dishwasher” web page (see FIG. 9). Preferably, the “dishwasher” web page includes help text 902 and a dishwasher specific model number location diagram 904.

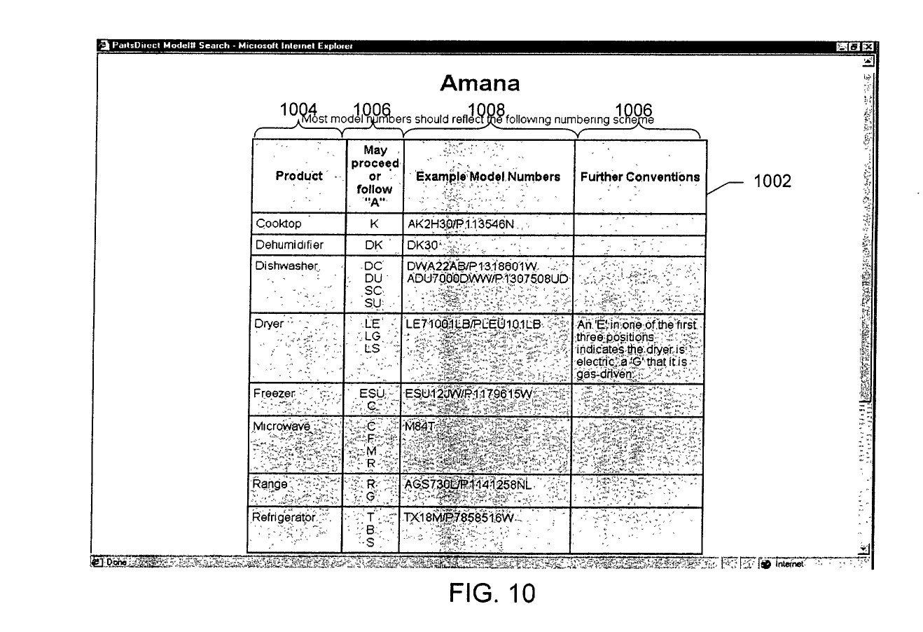

If the user selects one of the “product brand” hyperlinks 804, the server 104 preferably responds with specific products under that brand and model number conventions used by that brand (step 508). For example, if the user selects the “Amana” hyperlink 808, the replacement parts website server 104 may respond with an “Amana” web page (see FIG. 10). Preferably, the “Amana” web page includes a chart 1002 detailing Amana products 1004, Amana model numbering conventions 1006, and Amana model number examples 1008.

Once the user determines the model number associated with the product for which he desires a replacement part, the user preferably enters the model number into the “model number” data entry box 704, and the user's client device 102 transmits the model number (or any other type of product identifier) to the replacement parts website server 104 (step 510). Alternatively, the user may enter the specific part number of interest in to the “part number” data entry box 706, if the part number is known. In such an instance, the process 500 may go directly to step 518 which is described in detail below.

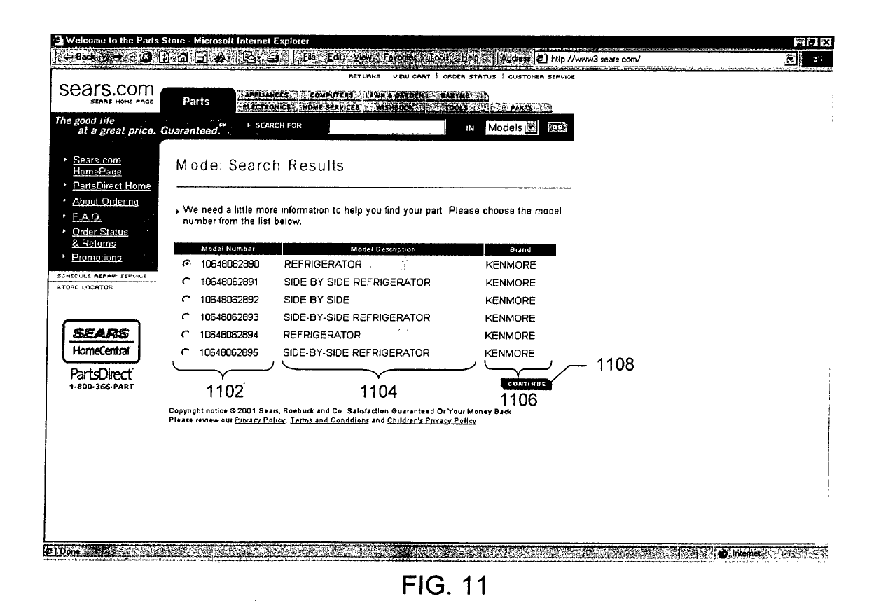

In some instances, the model number entered by the he user may be generic to several similar products, or the user may not be able to locate his model number. In such an instance, the replacement parts website server 104 may transmit a “model number selection” web page (see FIG. 11). The “model number selection” web page preferably includes a plurality of model numbers 1102, a plurality of corresponding model descriptions 1104, a brand identifier 1106, and a “continue” button 1108. Preferably, the user selects a specific model from the plurality of model numbers 1102 and presses the “continue” button 1108.

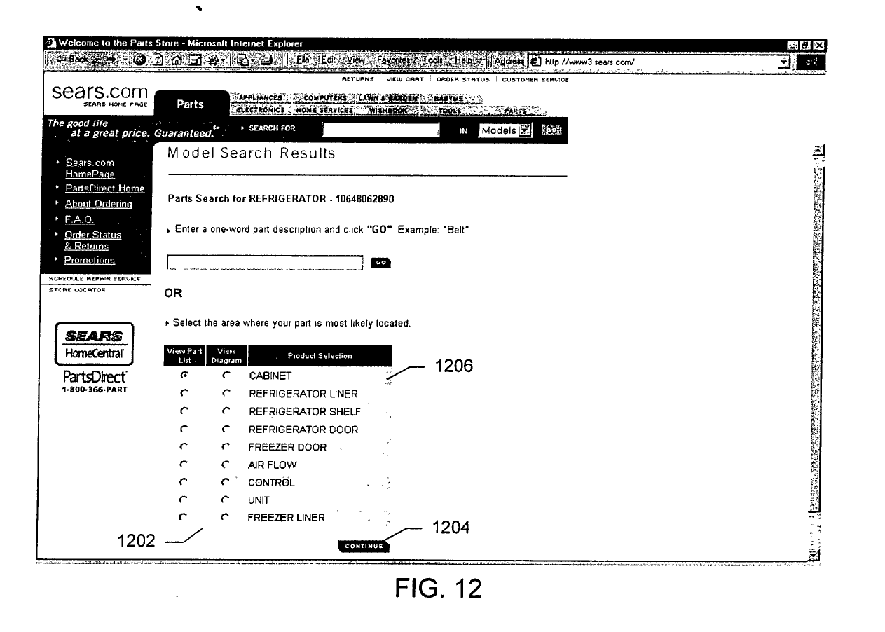

Similarly, many products may include several subsections. Accordingly, the replacement parts website server 104 may transmit a “subsection selection” web page (see FIG. 12). The “subsection selection” web page preferably includes a plurality of product subsection choices 1202 and another “continue” button 1204. Preferably, the user selects a product subsection from the plurality of product subsection choices 1202 and presses the “continue” button 1204. In response to the user selection, the client device 102 preferably transmits a product identifier (e.g., a model number and/or a subsection identifier) to the replacement parts website server 104 (step 510).

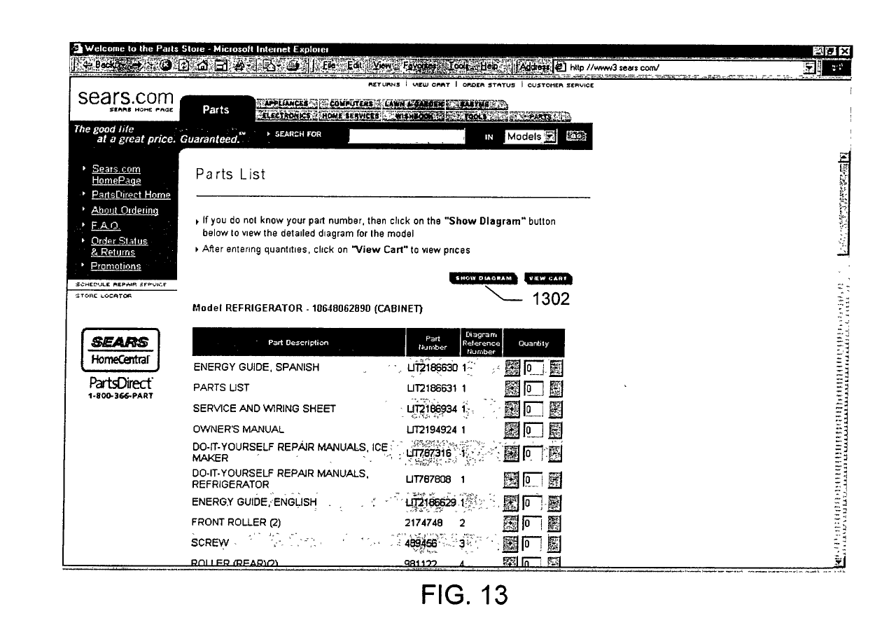

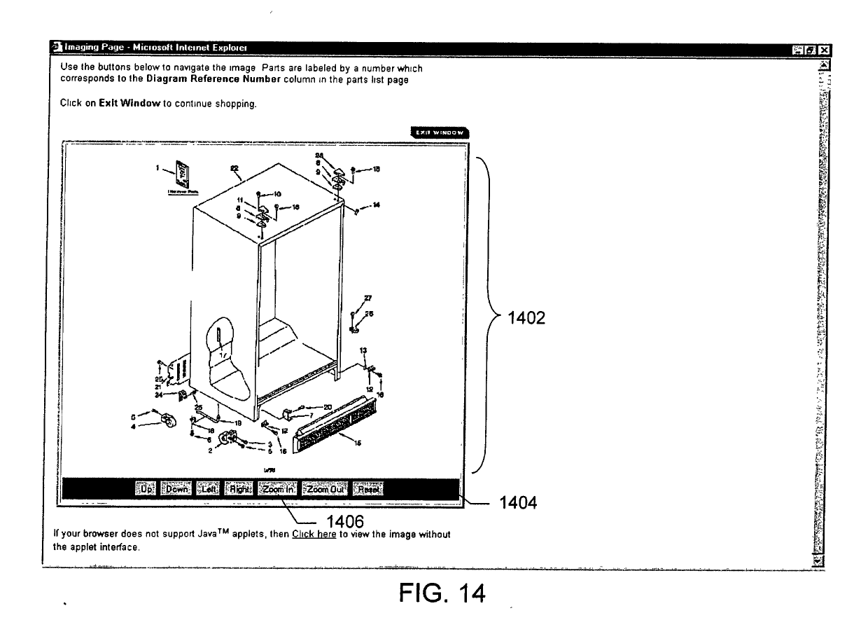

Regardless of how the product identifier is generated by the client 102 (e.g., entered into the “model number” data entry box 704, selected from a model number list 1102, and/or selected from a product subsection list 1202), when the replacement parts website server 104 receives the product identifier, the server 104 preferably responds by transmitting a list of replacement parts and/or an interactive exploded view of the product/subsection identified (step 512). For example, if the user selects the “cabinet” hyperlink 1206 of model number “10648062890” (see FIG. 12), the replacement parts website server 104 may respond with a “10648062890 (cabinet)” parts list web page (see FIG. 13). Subsequently, if the user selects a “show diagram” button 1302, the replacement parts website server 104 may respond with a “10648062890 (cabinet)” diagram web page (see FIG. 14).

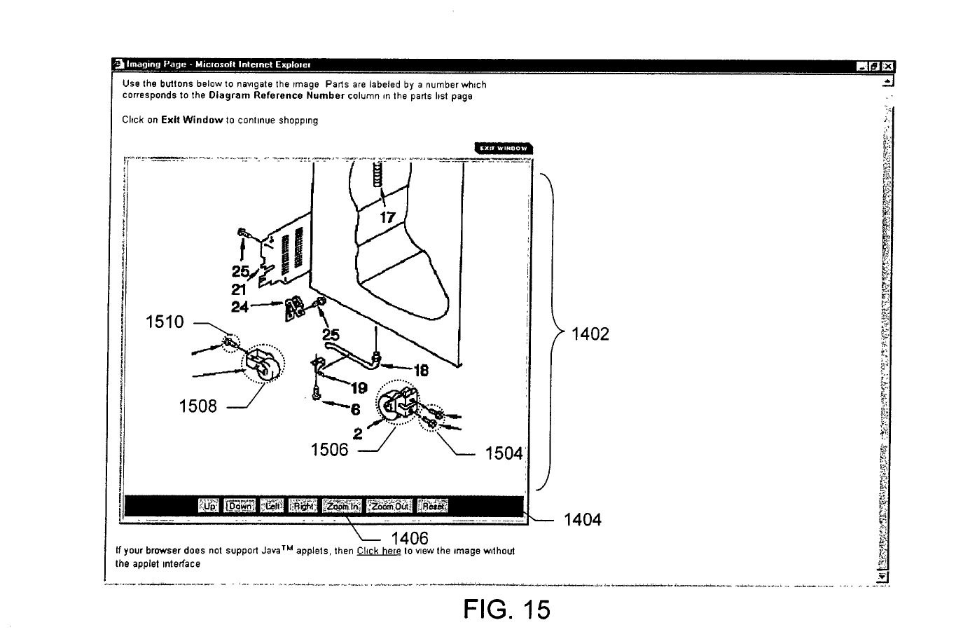

The diagram web page (FIG. 14) preferably includes an interactive exploded view 1402 and one or more view controls 1404. The view controls may be used to manipulate the interactive exploded view 1402. For example, if the user selects a “zoom in” button, the interactive exploded view 1402 preferably zooms in (see FIG. 15). Of course, a person of ordinary skill in the art will readily appreciate that many other control functions may be used to manipulate the interactive exploded view 1402. For example, the interactive exploded view 1402 may be panned in two dimensions and/or rotated in three dimensions. Preferably, software instructions structured to manipulate the interactive exploded view (e.g., a Java script) are transmitted to the client 102 from the replacement parts website server 104.

Preferably, the interactive exploded view also includes selectable regions 1504, 1506, 1508, 1510 over each replacement part which is available for purchase. Although several sample regions 1504, 1506, 1508, 1510 are shown as dashed circles in FIG. 15, a person of ordinary skill in the art will readily appreciate that the regions 1504, 1506, 1508, 1510 need not be visible or circular. In the preferred embodiment, each region 1504, 1506, 1508, 1510 is substantially the same shape the corresponding replacement part, and each region 1504, 1506, 1508, 1510 is invisible to the user. Alternatively, a generic X-Y coordinate system may be used. In such an instance, each region includes an x-axis coordinate and a y-axis coordinate (or a range of x and y coordinates).

When the user selects a region 1504, 1506, 1508, 1510, the user's client device 102 preferably transmits a region identifier to the replacement parts website server 104 (step 514). In response, the replacement parts website server 104 determines a part number based on the region identifier (step 516). For example, if the region identifier includes the part number, the part number may be determined by extracting the part number from the region identifier directly. Alternatively, the region identifier may be used to look up a part number in the database 314.

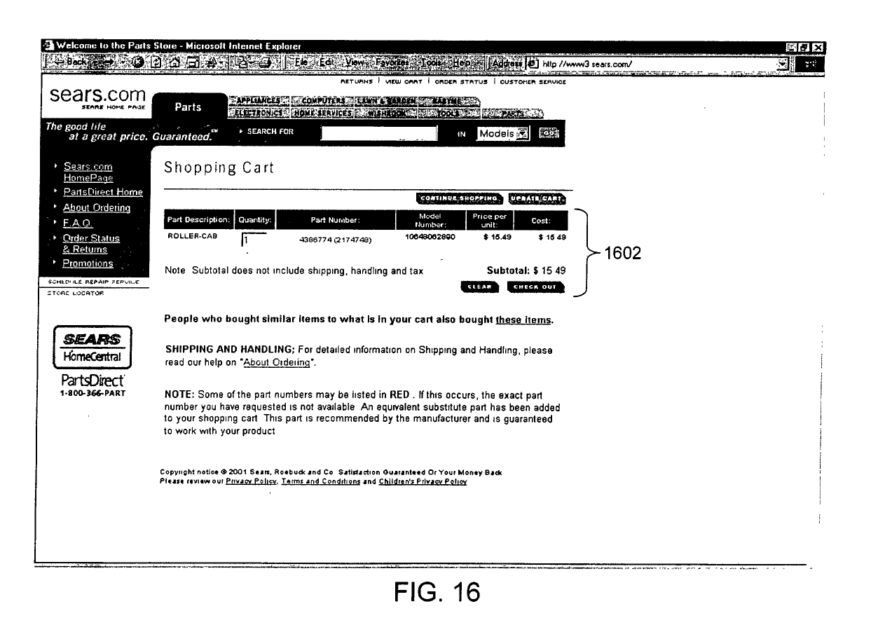

Once the part number is determined, the part number is preferably added to an electronic shopping cart 1602 in a well known manner (step 518). A screen-shot of an exemplary electronic shopping cart 1602 is illustrated in FIG. 16. At some point, the replacement parts website server 104 also receives customer identification information (step 520). The customer identification information preferably includes the user's name, address, and/or credit card number. Of course, a person of ordinary skill in the art will readily appreciate that any type of customer identification information may be used. For example, a password and/or cookie data may be used to identify a customer.

In addition, the replacement parts website server 104 preferably determines one or more vendors to supply the request parts (step 522). Preferably, vendor determination is based on predetermined vendor relationships recorded in the database 314. When more than one vendor (or vendor location) is available, the replacement parts website server 104 preferably selects one of the vendors (or locations) based on the location of the customer and/or the current price associated with the requested replacement part. Once a vendor is selected for each replacement part, one or more “order messages” are preferably transmitted to the appropriate vendor servers 106 (step 524). Each “order message” preferably requests delivery of one or more replacement parts directly to the customer's address. Subsequently, the vendor ships the replacement part(s) to the customer (step 526).

In summary, persons of ordinary skill in the art will readily appreciate that a method and apparatus for purchasing a replacement part for a product via the Internet with the aid of an interactive exploded view has been provided. Users of systems implementing the teachings described herein can enjoy fast and cost effective identification and purchasing of replacement parts for any size product.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A method of purchasing a replacement part for a product, the method comprising the steps of:
receiving a product identification message from a client device via a network, the product identification message identifying the product;
transmitting an interactive exploded view of a plurality of replacement parts associated with the product to the client device via the network, the interactive exploded view including an invisible overlay, the invisible overlay defining a plurality of regions associated with the interactive exploded view;
receiving a region identifier from the client device via the network, the region identifier uniquely identifying one of the plurality of regions associated with the interactive exploded view;
determining the replacement part based on the region identifier;
adding the replacement part to an electronic shopping cart in response to the step of determining the replacement part based on the region identifier;
receiving a customer identifier from the client device via the network; and
shipping the replacement part to a shipping address associated with the customer identifier.

2. A method of purchasing a replacement part as defined in claim 1, wherein the step of receiving a product identification message comprises the step of receiving a model number entered into a data entry box of a web page, the model number being associated with a plurality of part numbers.

3. A method of purchasing a replacement part as defined in claim 2, further comprising the step of transmitting a model number location diagram to the client device via the network, the model number location diagram facilitating location of the model number entered into the data entry box by a customer.

4. A method of purchasing a replacement part as defined in claim 1, wherein the step of receiving a product identification message comprises the step of receiving a part number entered into a data entry box of a web page, the part number being associated with a model number, the model number being associated with a plurality of part numbers.

5. A method of purchasing a replacement part as defined in claim 1, wherein the step of receiving a product identification message comprises the step of receiving a hyperlink selection from a web page.

6. A method of purchasing a replacement part as defined in claim 5, wherein the hyperlink selection is associated with a digital image representing the product.

7. A method of purchasing a replacement part as defined in claim 5, wherein the hyperlink selection is associated with a text message representing the product, the text message including a brand name associated with the product.

8. A method of purchasing a replacement part as defined in claim 1, wherein the step of transmitting an interactive exploded view of a plurality of replacement parts associated with the product comprises the step of transmitting data indicative of a rotatable three dimensional image.

9. A method of purchasing a replacement part as defined in claim 1, wherein the step of transmitting an interactive exploded view of a plurality of replacement parts associated with the product comprises the step of transmitting software instructions structured to manipulate the interactive exploded view.

10. A method of purchasing a replacement part as defined in claim 1, wherein each region in the plurality of regions associated with the interactive exploded view corresponds to a part in the plurality of replacement parts associated with the product.

11. A method of purchasing a replacement part as defined in claim 1, wherein the step of receiving a region identifier from the client device comprises the step of receiving a region name.

12. A method of purchasing a replacement part as defined in claim 1, wherein the step of receiving a region identifier from the client device comprises the step of receiving a region number.

13. A method of purchasing a replacement part as defined in claim 1, wherein the step of receiving a region identifier from the client device comprises the step of receiving an x-axis coordinate and a y-axis coordinate.

14. A method of purchasing a replacement part as defined in claim 1, wherein the step of determining the replacement part based on the region identifier comprises the step of looking up a part number associated with the replacements part in a parts database using the region identifier as a key into the parts database.

15. A method of purchasing a replacement part as defined in claim 1, wherein the step of receiving a customer identifier from the client device via the network comprises the step of receiving a user name and a password from the client device via the network.

16. A method of purchasing a replacement part as defined in claim 1, wherein the step of receiving a customer identifier from the client device via the network comprises the step of receiving cookie data from the client device via the network.

17. A method of purchasing a replacement part as defined in claim 1, further comprising the steps of selecting a particular vendor facility from a plurality of vendor facilities, the particular vendor facility being associated with the replacement part and transmitting order data to the particular vendor facility, the order data identifying the replacement part and the shipping address.

18. A method of purchasing a replacement part as defined in claim 1, wherein the network comprises the Internet.

19. A replacement part ordering system comprising:
a network receiver structured to receive data from a client device via a network;
a network transmitter structured to transmit data to a client device via the network;
a memory device storing a software program; and
a processor operatively coupled to the network receiver, the network transmitter, and the memory device, the processor being structured to execute the software program, the software program being structured to cause the processor to:
decode a product identification message received by the network receiver to identify a product;
cause the transmitter to transmit an interactive exploded view of a plurality of replacement parts associated with the product via the network transmitter, the interactive exploded view including an invisible overlay, the invisible overlay defining a plurality of regions associated with the interactive exploded view;
decode a region identifier received by the network receiver, the region identifier uniquely identifying one of the plurality of regions associated with the interactive exploded view;
determine the replacement part based on the region identifier; and
add the replacement part to an electronic shopping cart.

20. A replacement part ordering system as defined in claim 19, wherein the software program is further structured to cause the processor to determine a model number associated with the product.

21. A replacement part ordering system as defined in claim 19, wherein the software program is further structured to cause the processor to cause the transmitter to transmit a model number location diagram, the model number location diagram facilitating location of a model number by a customer.

22. A replacement part ordering system as defined in claim 19, wherein the software program is further structured to cause the processor to:
cause the transmitter to transmit a digital image representing the product; and
decode a hyperlink selection message, the hyperlink selection message being associated with the digital image representing the product.

23. A replacement part ordering system as defined in claim 19, wherein the software program is further structured to cause the processor to cause the transmitter to transmit data indicative of a rotatable three dimensional image depicting different views of the interactive exploded view.

24. A replacement part ordering system as defined in claim 19, wherein the software program is further structured to cause the processor to cause the transmitter to transmit software instructions structured to manipulate the interactive exploded view.

25. A replacement part ordering system as defined in claim 19, wherein each region in the plurality of regions associated with the interactive exploded view corresponds to a part in the plurality of replacement parts associated with the product.

26. A replacement part ordering system as defined in claim 19, wherein the software program is further structured to cause the processor to:
select a particular vendor facility from a plurality of vendor facilities, the particular vendor facility being associated with the replacement part; and
cause the transmitter to transmit order data to the particular vendor facility, the order data identifying the replacement part and a shipping address.

27. A replacement part ordering system comprising:
a network receiver operatively coupled to a network;
a network transmitter operatively coupled to the network;
a product identifier operatively coupled to the network receiver, the product identifier being structured to determine a product based on a product identification message received by the network receiver;
a product database storing a plurality of interactive exploded views, each interactive exploded view depicting a plurality of related replacement parts; each interactive exploded view including an invisible overlay defining a plurality of regions associated with the interactive exploded view;
a view manager operatively coupled to the product identifier, the product database, and the network transmitter, the view manager being structured to retrieve an interactive exploded view from the plurality of interactive exploded views stored in the product database, the interactive exploded view being associated with the product, the view manager being structured to transfer the interactive exploded view to the network transmitter;
a part determination module operatively coupled to the network receiver, the part determination module being structured to determine a replacement part based on selected region data received by the network receiver; and
a memory device operatively coupled to the part determination module, the memory device being structured to store an electronic shopping cart, the electronic shopping cart including data indicative of the replacement part.

28. A replacement part ordering system as defined in claim 27, wherein the memory device stores a model number location diagram, the model number location diagram facilitating location of a model number by a customer.

29. A replacement part ordering system as defined in claim 27, wherein the memory device stores data indicative of a rotatable three dimensional image, the rotatable three dimensional image depicting different views of the interactive exploded view.

30. A replacement part ordering system as defined in claim 27, wherein the memory device stores software instructions structured to manipulate the interactive exploded view.

31. A replacement part ordering system as defined in claim 27, further comprising a vendor selection module operatively coupled to the part determination module, the vendor selection module being structured to select a particular vendor from a plurality of vendors based on the replacement part, the particular vendor being associated with the replacement part.
